(19) United States
(12) Patent Application Publication
(10) Pub. No.: US 2020/0265761 A1
(43) Pub. Date: Aug. 20, 2020

(54) CORE TRAY AND MARKING METHOD

(71) Applicant: Kevin Dormer, as Trustee of the Dormer Family Trust, GYMPIE (AU)

(72) Inventor: SPENCER DORMER, GYMPIE (AU)

(73) Assignee: Kevin Dormer, as Trustee of the Dormer Family Trust, GYMPIE (AU)

(21) Appl. No.: 16/795,438

(22) Filed: Feb. 19, 2020

(30) Foreign Application Priority Data
Feb. 19, 2019 (AU) 2019900537

(51) Int. Cl. G09G 3/04; B65D 1/36; B65D 25/10

(52) U.S. Cl. CPC G09G 3/04; B65D 1/36; G09G 2354/00; G09G 2380/04; B65D 25/10

(57) ABSTRACT

This invention relates to the standardised marking of a core tray or an ancillary part thereof with indicia for machine reading that identify a sample held therein, wherein an arrangement of segments adapted to be altered in appearance is formed in a recurrent pattern on a surface of the tray, so that when selected segments in each pattern have been altered in a standard manner by human hand, the arrangement represents a sequence of machine-readable, standardised alphanumeric characters.

### CROSS REFERENCE TO RELATED APPLICATIONS

This application claims the benefit of earlier filing date and right of priority to Australian Patent Application No. AU 2019900537, filed 19 Feb. 2019, the contents of which is incorporated by reference herein in its entirety.

### BACKGROUND OF THE INVENTION

### 1. Field of the Invention

This invention relates to the identification of a mineral sample carried in a core tray by marking the tray or an ancillary part thereof with indicia that identify a sample held therein. The invention provides for standardized marking of a core tray by a human hand for machine reading.

### 2. Description of Related Art

A core tray is a piece of apparatus widely used in the geological exploration industry to hold core drill samples obtained for analysis of the geology of a mining prospect area. Core trays are described in numerous published patents and applications, examples including Australian patent numbers 2016204774 and 2017213568.

An aspect of concern to users of core trays is that of marking them to identify their contents. Because of the robust, generally outdoor environment in which samples are obtained and the constant exposure to the elements, it is found that ordinary means of marking trays to identify the samples within tend to be inadequate.

One prior method of marking trays involves inserting a separate written label into a display slot at an end of the tray or on a side. A drawback is that the labels are easily visible and are attractive targets for vandals or saboteurs, as they can easily be removed and swopped over from one tray to another. Another drawback is that the handwriting inscribed on a label is often not easy to decipher, resulting in misreading of information. Both drawbacks have significant negative economic consequences because of the reliance on the core sample identity in informing decisions, typically whether or not to mine the area from which the sample was obtained.

### BRIEF SUMMARY OF THE INVENTION

It is an object of this invention to address the shortcomings of the prior art and, in doing so, to provide a method and means for marking a core tray in a mineral exploration environment, using standardised characters.

Another object is to provide a means of providing a machine-readable inscription on a core holding or storage device, wherein the inscription is at least partially applied by hand.

The preceding discussion of the background to the invention is intended to facilitate an understanding of the present invention. However, it should be appreciated that the discussion is not an acknowledgement or admission that any of the material referred to was part of the common general knowledge in Australia or elsewhere at the priority date of the present application.

Further, and unless the context clearly requires otherwise, throughout the description and the claims, the words ‘comprise’, ‘comprising’, and further derivations are to be construed in an inclusive sense—that is to say, in the sense of “including, but not being limited to”—as opposed to an exclusive or exhaustive sense—that is meaning “including this and nothing else”.

According to a first aspect of the invention, there is provided a method of enabling standardized marking of a core tray by a human hand for machine reading, the method including the steps of:
a. providing a core tray having a surface on which is displayed a pattern comprising a plurality of visually alterable segments; and
b. altering the appearance of at least one selected segment to form a character in a standardized form, the character formed being determined by the segments selected for altering.

Preferably, the character, when formed, is a combination of altered and unaltered segments.

In a preferred form of the invention, the character when formed from the altered segments is machine-readable.

In the method, the surface of the tray is preferably an exposed surface portion that is visible to an onlooker when the tray has been fully loaded with mineral samples. Further preferably, the surface is visible when the tray is stacked on a like tray.

In a preferred form of the invention, the method includes providing a sequence of visible patterns on the surface portion, the patterns being identical until altered by hand.

Preferably, the surface portion is substantially flat. Further preferably, the surface portion is located to be upwardly facing.

Most preferably, the surface portion is located between an outer lateral edge of the tray and a mineral sample-receiving channel of the tray closest to said edge.

In an embodiment, the method includes forming the patterns during manufacture of the tray. Preferably, the patterns are formed during moulding of the tray.

In a preferred embodiment, the method includes the step of providing the patterns wherein the segments are formed as uniform elongate indentations on the surface.

In an alternative embodiment, the segments are provided in the form of elongate raised uniform formations protruding from the surface.

Preferably, at least three of the formations are arranged in parallel lines.

In a further preferred embodiment, the formations are seven in number with three formations being arranged to be oriented substantially at right angles to the remaining four.

In a still further preferred embodiment, the formations are arranged to form a FIG. 8.

In a preferred form of the invention, the step of altering the visual appearance of the patterns includes applying colouring to one or more selected segments that differs substantially from the colour of the tray surface.

In an embodiment, the colouring applied to the selected segments is selected to be sufficiently different from the colour of the tray surface portion to be detectable by a processor running a colour-differentiating software application.

In a preferred embodiment, the colouring applied to the selected segments is selected to be sufficiently different from the colour of the tray surface portion to be detectable by a human applying colouring to the selected segments.

Preferably, the method includes applying the colouring with a permanent marking pen.

In an embodiment, the method includes marking only segments that are not required for forming a representation of a required character.

In a preferred embodiment, the method includes marking only segments that are required for forming a representation of a required character.

In a further embodiment, the surface on which the patterns and segments are displayed is located on a pod or block that is removably insertable in a core tray channel.

According to a second aspect of the invention, there is provided a method of marking a core tray with data relating to a sample held in the tray, the method comprising the steps of:
a. providing a tray and forming on a surface thereof an arrangement of segments adapted to be altered in appearance, so that when selected segments have been altered in a standard manner, the arrangement represents an alphanumeric character; and
b. causing selected segments to be altered so that the arrangement represents a predetermined alphanumeric character.

In a preferred embodiment, the arrangement comprises at least seven separate elongate linear segments adapted for individual marking. Preferably, the seven segments are arranged to form a figure ‘8’ pattern.

The method may include allowing a human to select and mark at least one of the segments to define an alphanumeric character or punctuation mark, said character or punctuation mark representing a property or characteristic of the sample in the tray. The human may also form the character by marking segments not required to form the character, so that unmarked segments represent the character.

In a preferred form of the invention, the method includes providing separate sequences of arrangements, defining data fields for populating by a human marking the tray.

In an embodiment of the method, the surface on which the segments are located is provided on an ancillary removable part of the tray. The removable part may be a core block or a sample containing pod insertable in a core-receiving channel of the tray.

According to a third aspect of the invention there is provided a core tray having a surface portion comprising a pattern of elongate segments that are of alterable appearance, so that when altered, the pattern forms an alphanumeric character in a substantially standardized form which is machine-readable.

In a preferred form of the invention, the segments are identical.

In a preferred embodiment, each segment is defined by a depression in the surface portion.

In a further preferred embodiment, the segments are seven in number.

Preferably, at least three of the segments are axially parallel.

The seven segments are further preferably located to form a figure ‘8’.

In a preferred form of the invention, the segments are adapted to be machine readable by virtue of the means by which they are marked.

In an embodiment, the marking means comprises a photo-fluorescent compound or a photo-phosphorescent compound.

In a further embodiment, the segments are located on a removable ancillary part of the tray assembly. Such removable part may be a core block or a sample containing pod.

### BRIEF DESCRIPTION OF THE DRAWINGS

In order that the invention may be readily understood, and put into practical effect, reference will now be made to the accompanying figures. Thus:

FIG. 1 shows in schematic form a diagram of a preferred embodiment of the marking indicia of this invention.

FIG. 2 is a schematic diagram of the indicia of FIG. 1 treated to alter appearance to a numerical character.

FIG. 3 shows in top perspective view a core tray having the marking means of FIG. 1 applied.

FIG. 4 shows in a close-up plan view a corner section of the tray of FIG. 3 bounded by the call-out box labelled “A”, to which the indicia of the invention have been applied for use.

FIG. 5 is an illustration of an alternative form of character blank that may be used instead of the blank in FIG. 1.

FIG. 6 illustrates in upper perspective view an embodiment in which the invention is applied to a sample-holding pod that is adapted to fit within a core tray of conventional design.

FIG. 7 is a perspective view showing pods of FIG. 6 being fitted into a core tray of known design.

FIG. 8 is a perspective view of a core block having a sequence of digit patterns of FIG. 1 on its exposed upper surface.

While the embodiments and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DETAILED DESCRIPTION OF THE INVENTION

The invention will be described below with particular reference to a core sample holding tray or “core tray.” However, it may be applied effectively to other ancillary items used with core trays, for example a block or a sample pod, both of which have an upper exposed surface suitable for application of patterns according to the invention.

The term “pod” is employed to describe a container of relatively small size relative to a core tray. Indeed, a pod is designed and configured to be placed within a channel of a core tray, in which it is then carried and the sample within it stored. The pod may be thought of as a storage module or referred to as a “boat”. A block, although not intended to contain a mineral sample, is also placed within a core tray channel and can be used to separate core samples within a tray.

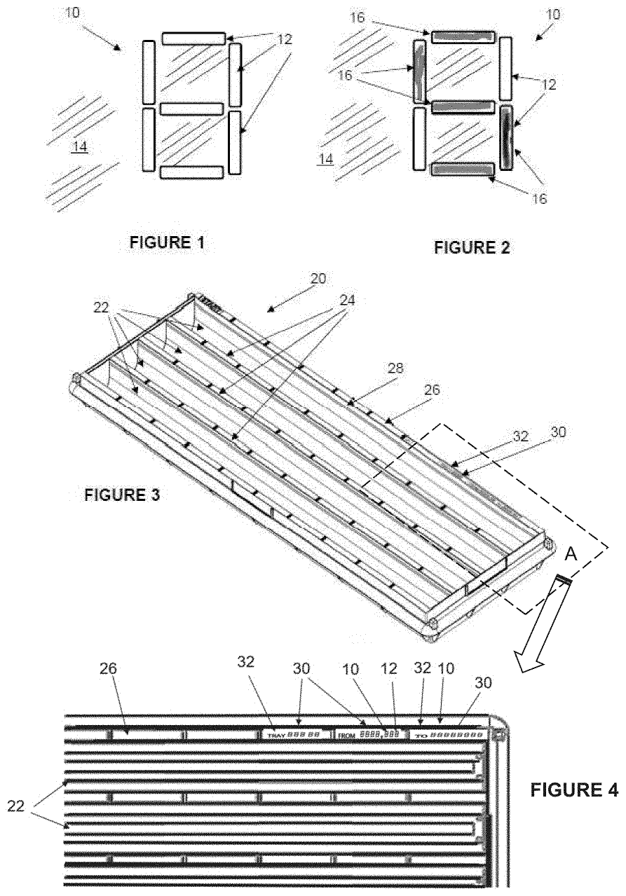

Referring to FIG. 1, in a preferred embodiment of this invention, an arrangement of individual segments is generally denoted by the number 10 and shown in plan view. The segments 12 comprise evenly sized elongate formations in the form of female depressions moulded into the outer surface 14 of a tray during manufacture, so that they are readily visible to a human observer and to an electronic scanner or camera for digital capture and uploading to an electronic memory device (not shown).

When a human official, who has been authorised to do so, wishes to apply an identifying indicium to the tray, so as to provide means of identifying the sample (not shown) in the tray, the official will identify a selection of segments to alter in appearance to form from the altered segments a predetermined alphanumeric character. The official will alter the appearance of the relevant depression in the selection by colouring it in with an indelible marker, preferably one with a broad applicator. The colour of the marker should be one that contrasts well with the colour of the tray. Typically, the marker colour will be black or a dark blue when the tray is of a light colour such as grey or beige. To ease the burden on colour-differentiating software that may be used for machine-reading of the digits formed by the human colouring action, it is preferable that the colour of the market should contrast significantly with the colour of the surface on which the patterns to be altered are formed. It is within the scope of the invention that marking may be by means of applying a photo-fluorescent compound or a photo-phosphorescent compound to the relevant selected segments using a marking instrument charged with and adapted to dispense such a compound. Such instrument is preferably a marking pen having a phosphorescent ink of known design.

By way of example, if the official wishes to form the number ‘5’, he will do so by applying the marker to the depressions 16 marked in FIG. 2. To form the numeral 1, the user will colour in the two vertically disposed segments on the left or on the right. By convention, it may be decided in an organization to choose left or right only. If all the outer segments are shaded in, the numeral ‘0’ will be formed. If all segments are shaded, the number formed will be ‘8’ and so on. If a “dash” is required, only the central horizontal segment need be shaded in.

Clearly, a single digit will usually be insufficient for labelling a core sample. Additional arrangements 10 of patterned segments 12 may be placed adjacent the arrangement in FIGS. 1 and 2 to provide for the formation of a string of numerals to signify a quantity or to display a sequence that represents a code, a date, location co-ordinates or drilling depth and the like. The numbers provide information about the sample that will be logged and archived for later use.

Typically, when planned drilling will not exceed 1000 m depth, only five patterns are needed, three before and two after a decimal point. The decimal point may be pre-coloured or left uncoloured relative to the tray colour, for filling in by the user. In the case of trays intended to retain samples retrieved from deeper mineral strata, a fourth or even a fifth character pattern may be provided in a line with the others to the left of the decimal point.

The representation of a sequence of numerals is shown in FIG. 3. Here a core tray 20 of conventional known design comprises depressions in the form of parallel channels 22 separated by walls 24. On a flat top section 26 of an outer wall 28 there is formed a sequence 30 of pattern arrangements 10 of depressions 12, preceded by a word 32 relating to the sequence. Word 32 informs the official forming the numerals in sequence 30 as to the data field that the numerals and sequence are intended to represent. The examples shown in FIG. 4 are the words “TRAY” which may refer to the number allocated to the sample, or to the tray itself, and “FROM” and “TO”, which may refer to drilling hole depth levels, between which the core was extracted.

The word in this embodiment is fixed in the sense that it cannot be altered. It is formed with raised male segments. These are moulded into the exposed surface on the top of the side wall when tray 20 is manufactured. Typically, the tray is manufactured from a rigid plastics compound such as high-density polyethylene (HDPE), polyvinyl chloride (PVC) or acrylonitrile butadiene styrene (ABS) and is moulded by an injection moulding process of known type.

In alternative embodiments, word 32 may be differently formed and represented. For example, it may be applied after manufacture of the tray by an embossing method. Other methods may be apparent to those of skill in the art. Such methods should we considered to fall within the scope of this invention, being to the method of providing standardised machine-readable markings on the tray, even though the markings are made by the human hand.

In the embodiment of FIG. 3, the words “Tray #”, “From:”, and “To:” are raised male letters formed into the core tray during manufacture by the chosen injection moulding process. These describe data fields to be populated with data pertaining to the sample, as described previously. The sequence of patterns that follows each word, comprising figure ‘8’ digits, are female indents that the user writes in with a permanent marker pen after logging the sample in the field. This is done so that the optical character recognition (OCR) process is able to be applied within the sample logging software. The processor is able more easily to recognize the most critical of the data on the photographic images of the tray and automatically to rename the image inside the software, according to the “Tray” number (#), “From” and “To” fields.

Prior to this invention, the recognition and renaming has been a manual task that takes countless man-hours, as well as being prone to much human error.

For later reading of the numerals of sequence 30, the tray is brought into a reading zone of a digital visual reading device, such as a digital camera, feeding image data to a computer data processor, running optical character recognition software of known design. The digital camera may be contained in a mobile telephone handset which also contains the processor running the software on board. The recognized characters may be stored on board the handset for later uploading, or may be automatically communicated to a remote server. The image data may alternatively be uploaded immediately to a remote server for processing and data storage.

In another embodiment, a handheld scanner is utilized for acquiring an image of sequence 30. The scanner is configured to store locally or upload the image to a remote server for processing, or to process the image on board before uploading it to a remote server.

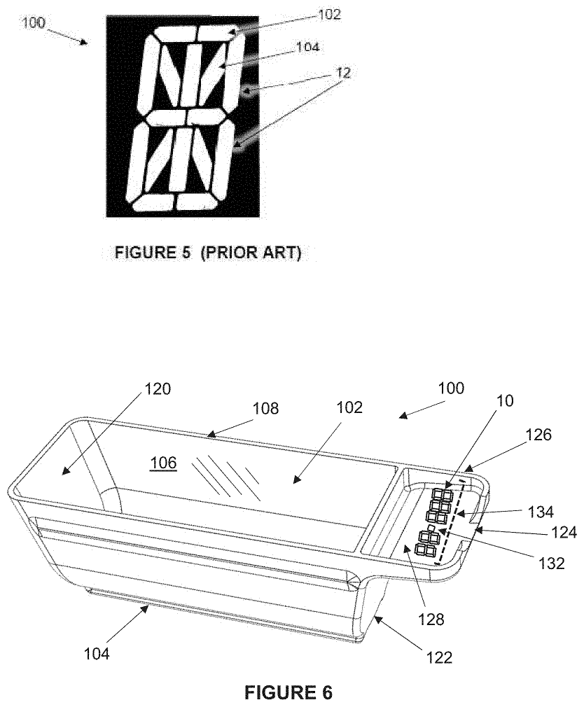

It will be appreciated that by making use of a 16-segment pattern 100 as shown in FIG. 5, this being an example of a known arrangement of segments, not only numerical digits but also alphabet characters in a standardized form can be formed by the person applying the marking. This broadens the range of characters that can be represented. Apart from segments 12, there are less elongate segments 102 and diagonal segments 104 that the marker may in effect “switch on” by colouring them.

Although the invention has been described with the example of the pattern segments being altered by colouring, it is within the scope that alteration may be accomplished by changing surface texture within the segments. By way of example, they may be rendered highly reflective, or have reflectance reduced by applying a light reflecting or a light absorbing coating, or an agent that fluoresces under exposure to selected electromagnetic radiation frequencies. These may be utilized to enhance digital image capture. They need also be visible to the naked eye of the person applying the treatment substance.

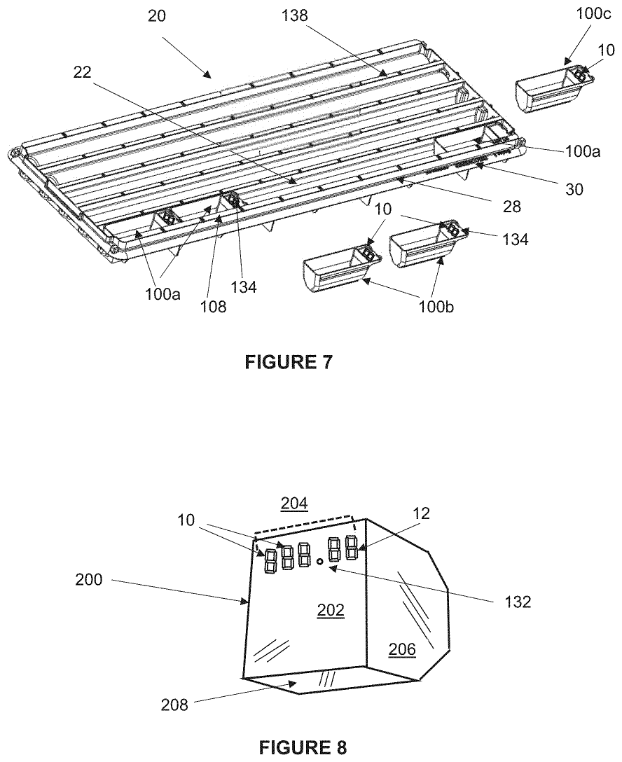

In FIG. 6, an embodiment of the invention being applied to a sample-holding pod 100 is illustrated. It is apparent that the pod resembles the general shape of a boat, having a hull and a protruding rear deck 124, referred to in nautical terms as the “poop deck”. This area also serves as a suitable surface area for marking the sample. The pod has a receptacle space 102 defined by the hull, which comprises a base 104 and a surrounding upstanding wall 106, terminating with an upper rim 108. The hull has a front end 120 and a rear end 122, both arbitrarily named for convenience of differentiation. From the rear end deck extends, serving as a spacer in use in relation to another pod that may be placed in the same channel of the tray, as shown in FIG. 7. The spacer has peripheral edges 126 around the flat deck-like surface 128. The protruding deck provides a handle for gripping by a human handler and manipulating the pod into place in one of the tray channels, labelled 22 in FIG. 3. The flat surface of the deck portion 128 provides a location for an identification indicium, depicted here as a sequence 134 of four of the segmented digit-defining patterns 10 of the invention shown in the embodiment of FIGS. 1 and 2. The patterns are grouped in a 3:1 formation with a dash-like projection 132 between the third and fourth pattern 10. Each pod may therefore have its own unique identifying sequence of hand-adjusted segments forming the characters 10 in sequences 134 of indicia. In addition, the tray 20 has its own identifying sequence 30 as discussed in relation to FIG. 3.

The pod is shaped to fit snugly into the relevant receiving channel 22 with rim 108 substantially coinciding in level with the lip of the tray side 28. By not protruding above the lip of the channel, the pod avoids the possibility of preventing a like tray from being stacked on to the tray containing the pod of this embodiment. The handle structure provided by projecting spacer 124 serves a useful purpose of spacing the rear end of the tray to which it is attached from either an end wall of the tray within which it is located in use, or from the front end of a tray in linear alignment with it for reasons explained next.

A snug fit for the pod into the channel is advantageous as the friction fit achieved assists in preventing the pod from being easily displaced. The fit should be snug, but not so tight as to cause noticeable deformation of the pod and of the tray channel when inserted therein. The fit should also not be so tight as to cause a handler to use excessive force in removing the pod from the channel in a manner that results in an uncontrolled jerk that ejects or displaces mineral materials from the pod. It is preferable that the pod dimensions result in the external side surfaces of the pod brushing against the adjacent side surfaces of the channel and that the handler is not obliged to force the pod into position.

In a further embodiment, there is provided a sequence of character patterns for each channel in the tray. The segments for the character patters are formed in the top surfaces 138 of the walls separating the channels. In a further embodiment, a segment-receiving surface is provided at an end of each channel.

The invention is also applied to the core separation blocks adapted to be placed in a channel 22 of a tray 20. An example is illustrated in FIG. 8. These “core blocks” 200 are removably inserted into the channels 22 of the trays between discrete samples. There may be up to about five such blocks per tray, each having drilling data inscribed on them according to the method of the invention. Thus block 200 has a planar upper surface 202 on which a sequence 204 of patterns 10 of segments 12 is inscribed in a 3:2 separated configuration, as shown in FIG. 6.

The block has a profiled axial shape as shown on end face 206, adapted to complement the shape of the tray channel into which it will be placed in use. The block is solid, and has opposite lateral faces 208. In other embodiments the block may be hollow. However, manufacture by extrusion is preferred to allow blocks to be cut to required length on site, if necessary, according to core sample length.

An advantage achieved with the invention is that by shading or otherwise altering the appearance the selected segments for forming a required character, the person doing the marking is substantially constrained to form the character is a standardized form that is easily readable by other individuals as well as being easily processed by a processor running character recognition software. This reduces human error in marking the core tray in the first place and in reading in the second place. It also reduces machine reading error. The result is more accurate logging, identification, archiving and retrieval of mineral samples.

These embodiments merely illustrate specific examples of the method and means of the invention for enabling standardized marking of a core tray by a human hand for machine reading. With the insight gained from this disclosure, the person skilled in the art is well placed to discern further embodiments by means of which to put the claimed invention into practice.

What is claimed is:

1. A method of enabling standardized marking of a core tray by a human hand for machine reading, the method including the steps of:
providing a core tray having a surface on which is displayed a pattern comprising a plurality of visually alterable segments; and
altering the appearance of at least one selected segment to form a character in a standardized form, the character formed being determined by the segments selected for altering.

2. The method of claim 1, wherein the character, when formed from the altered segments, is machine-readable.

3. The method of claim 1, wherein the surface of the tray is an exposed surface portion that is visible to an onlooker when the tray has been fully loaded with mineral samples.

4. The method of claim 3, including providing a sequence of the visible patterns on the surface portion, the patterns being identical until altered by hand.

5. The method of claim 1, including the step of providing the patterns wherein the segments are formed as uniform indentations on the surface.

6. The method of claim 5, wherein the segments are seven in number with three segments being arranged to be oriented substantially at right angles to the remaining four.

7. The method of claim 1, wherein the step of altering the visual appearance of the patterns includes applying colouring to one or more selected segments that differs substantially from the colour of the tray surface, wherein the colouring applied to the selected segments is selected to be sufficiently different from the colour of the tray surface portion to be detectable by a processor running a colour-differentiating software application.

8. The method of claim 7, including marking only segments not required for forming a representation of a required character.

9. The method of claim 1, wherein the surface on which the patterns and segments are displayed is located on a pod or block that is removably insertable in a core tray channel.

10. A method of marking a core tray with data relating to a sample held in the tray, the method comprising the steps of:
providing a tray and forming on a surface thereof an arrangement of segments adapted to be altered in appearance, so that when selected segments have been altered in a standard manner, the arrangement represents an alphanumeric character; and
causing selected segments to be altered so that the arrangement represents a predetermined alphanumeric character.

11. The method of claim 10, wherein the arrangement comprises at least seven separate elongate linear segments adapted for individual marking, and wherein the seven segments are arranged to form a figure ‘8’ pattern.

12. The method of claim 10, including allowing a human to select and mark at least one of the segments to define an alphanumeric character or punctuation mark, said character or punctuation mark representing a property or characteristic of the sample in the tray.

13. The method of claim 10, including allowing a human to select and mark at least one of the segments not required to form the character, so that unmarked segments represent the character.

14. The method of claim 10, including providing separate sequences of arrangements, defining data fields for populating by a human marking the tray.

15. A core tray having a surface portion comprising a pattern of elongate segments that are of alterable appearance, so that when altered, the pattern forms an alphanumeric character in a substantially standardized form that is machine-readable.

16. The core tray of claim 15, wherein the segments are identical.

17. The core tray of claim 15, wherein each segment is defined by a depression in the surface portion.

18. The core tray of claim 15, wherein the segments are seven in number.

19. The core tray of claim 15, wherein the segments are adapted to be machine readable by virtue of the means by which they are marked.

20. The core tray of claim 15, wherein the segments are located on a removable ancillary part of the tray.
